(19) United States
(12) Patent Application Publication
(10) Pub. No.: US 2014/0109303 A1
(43) Pub. Date: Apr. 24, 2014

(54) Protective Garment with Magnetic Closures

(71) Applicant: LION APPAREL, INC., Dayton, OH (US)

(72) Inventor: Nicholas J. Curtis, Liberty Township, OH (US)

(73) Assignee: LION APPAREL, INC., Dayton, OH (US)

(21) Appl. No.: 13/657,374

(22) Filed: Oct. 22, 2012

(51) Int. Cl. A62B 17/00; A41D 13/00

(52) U.S. Cl. 2/455

(57) ABSTRACT

A protective garment including an outer shell made of an abrasion resistant material that resists igniting, burning, melting, dripping, or separation when exposed to a temperature of 500° F. for five minutes. The garment includes a pocket generally positioned on or inside the outer shell and a magnetic closure system configured to retain the pocket in a closed position. The magnetic closure system resists igniting, burning, melting, dripping, or separation when exposed to a temperature of 500° F. for five minutes.

This application relates to protective garments, and more particularly, to protective garments having pockets or other closable components.

### BACKGROUND

Protective or hazardous duty garments are used in a variety of industries and settings to protect the wearer from hazardous conditions such as heat, smoke, cold, sharp objects, chemicals, liquids, fumes and the like. The protective garments may have pockets in which the wearer can store loose items. In many situations, the wearer may need to bend, stoop, crawl or be placed in other circumstances which can cause the contents of the pocket to fall out.

### SUMMARY

A protective garment including an outer shell made of an abrasion resistant material that resists igniting, burning, melting, dripping, or separation when exposed to a temperature of 500° F. for five minutes. The garment includes a pocket generally positioned on or inside the outer shell and a magnetic closure system configured to retain the pocket in a closed position. The magnetic closure system resists igniting, burning, melting, dripping, or separation when exposed to a temperature of 500° F. for five minutes.

### BRIEF DESCRIPTION OF DRAWINGS

FIG. 1 is front perspective view of one embodiment of the garment of the present invention, with portions of various layers cut away for illustrative purposes;

FIG. 2A is a cross section taken along line 2-2 of FIG. 2A;

FIG. 2B shows the cross section of FIG. 2A, with the pocket flap slightly opened and the inner volume of the pocket slightly expanded;

FIG. 3 is an exploded perspective view showing a pouch receiving a piece of magnetic or magnetizable material;

FIG. 4 is a perspective view showing a coat with a front panel folded back to expose an alternate embodiment of the pocket; and

FIG. 5 is a cross section taken along line 5-5 of FIG. 4.

### DETAILED DESCRIPTION

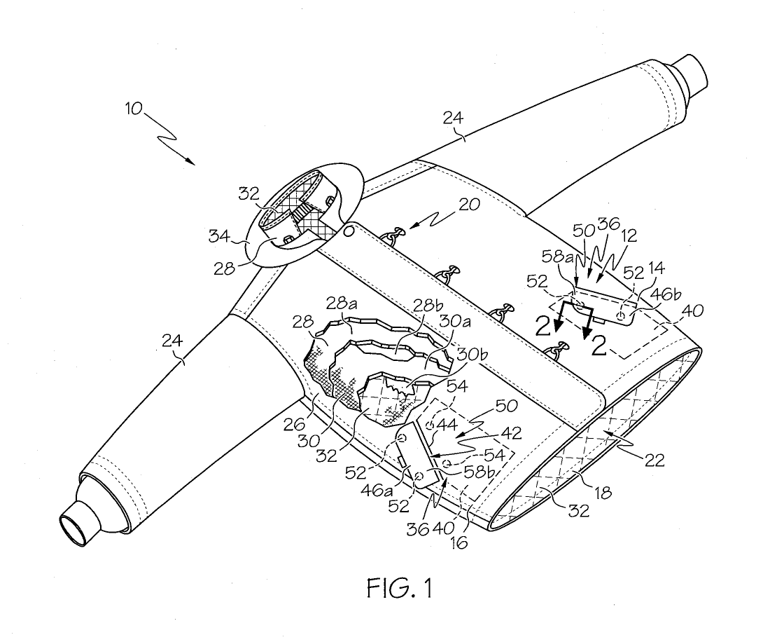

FIG. 1 illustrates a protective or hazardous duty garment in the form of a firefighter's coat, generally designated 10. The coat 10 may include a body portion 12 having a left front panel 14, right front panel 16 and a back panel 18. The left front panel 14 and right front panel 16 may be releasably attachable by a fastener 20, such as a zipper, snaps, clasps, clips, hook-and-loop fastening material (i.e., VELCRO® fastening material), combinations of these components or the like. The body portion 12 may define a torso cavity 22 that is shaped and configured to receive a wearer's torso therein. The garment 10 may include a pair of sleeves 24 coupled to and extending generally outwardly from the body portion 12 and shaped to receive a wearer's arms therein.

The garment 10 may include various layers through its thickness to provide various heat, moisture and abrasion resistant qualities to the garment 10 so that the garment 10 can be used as a protective, hazardous duty, and/or firefighter garment. For example, the garment 10 may include an outer shell 26, a moisture barrier 28 located inside of and adjacent to the outer shell 26, a thermal liner or barrier 30 located inside of and adjacent to the moisture barrier 28, and an inner liner or face cloth 32 located inside of and adjacent to the thermal barrier 30.

The outer shell 26 may be made of or include a variety of materials, including a flame, heat and abrasion resistant material such as a compact weave of aramid fibers and/or polybenzamidazole fibers. Commercially available aramid materials include NOMEX and KEVLAR fibers (both trademarks of E.I. DuPont de Nemours & Co., Inc. of Wilmington, Del.), and commercially available polybenzamidazole fibers include PBI fibers (a trademark of PBI Performance Fabrics of Charlotte, N.C.). Thus, the outer shell 26 may be an aramid material, a blend of aramid materials, a polybenzamidazole material, a blend of aramid and polybenzamidazole materials, or other appropriate materials. The outer shell 26 can also be made of a thermostable organic polymer material, such as KERMEL® material sold by Kermel SAS of Colmar, France.

If desired, the outer shell 26 may be coated with a polymer, such as a durable, water repellent finish (i.e. a perfluorohydrocarbon finish, such as TEFLON® finish sold by E. I. Du Pont de Nemours and Company of Wilmington, Del.). The materials of the outer shell 26 may have a weight of, for example, between about five and about ten oz./yd².

The moisture barrier 28 and thermal barrier 30 may be generally coextensive with the outer shell 26, or spaced slightly inwardly from the outer edges of the outer shell 26 (i.e., spaced slightly inwardly from the outer ends of the sleeves 24, the collar 34 and from the lower edge of the garment 10) to provide moisture and thermal protection throughout the garment 10. The moisture barrier 28 may include a semi-permeable membrane layer 28a and a substrate 28b.

The membrane layer 28a may be generally water vapor permeable but generally impermeable to liquid moisture. The membrane layer 28a may be made of or include expanded polytetrafluoroethylene (“PTFE”) such as GORE-TEX or CROSSTECH materials (both of which are trademarks of W.L. Gore & Associates, Inc. of Newark, Del.), polyurethane-based materials, neoprene-based materials, cross-linked polymers, polyamid, or other materials. The membrane layer 28a may have microscopic openings that permit moisture vapor (such as water vapor) to pass therethrough, but block liquids (such as liquid water) from passing therethrough. The membrane layer 28a may be made of a microporous material that is either hydrophilic, hydrophobic, or somewhere in between. The membrane layer 28a may also be monolithic and may allow moisture vapor transmission therethrough by molecular diffusion. The membrane layer 28a may also be a combination of microporous and monolithic materials (known as a bicomponent moisture barrier), in which the microporous or monolithic materials are layered or intertwined.

The membrane layer 28a may be bonded or adhered to a substrate 28b of a flame and heat resistant material to provide structure and protection to the membrane layer 28a. The substrate 28b may be or include aramid fibers similar to the aramid fibers of the outer shell 26, but may be thinner and lighter in weight. The substrate 28b may be woven, non-woven, spunlace or other materials. In the illustrated embodiment, the membrane layer 28a is located between the outer shell 26 and the substrate 28b. However, the orientation of the moisture barrier 28 may be reversed such that the substrate 28b is located between the outer shell 26 and the membrane layer 28a.

The thermal barrier 30 may be made of nearly any suitable flame resistant material that provides sufficient thermal insulation. In one embodiment, the thermal barrier 30 may include a layer of bulk material 30a in the form of relatively thick (i.e. between about 1/16″- 3/16″) batting, felt or needled non-woven bulk or batting material. The bulk material 30a can include aramid fiber batting (such as NOMEX batting), aramid needlepunch material, an aramid non-woven material, an aramid blend needlepunch material, an aramid blend batting material, an aramid blend non-woven material, foam (either open cell or closed cell), or other suitably thermally insulating materials. The bulk material 30a may trap air and possess sufficient loft to provide thermal resistance to the garment 10.

The bulk material 30a may be quilted to a thermal barrier face cloth 30b which can be a weave of a lightweight aramid material. Thus, either the bulk material 30a alone, or the bulk material 30a in combination with the thermal barrier face cloth 30b, may be considered to constitute the thermal barrier 30. In the illustrated embodiment, the thermal barrier bulk material 30a is located between the outer shell 26 and the thermal barrier face cloth 30b. However, the orientation of the thermal barrier 30 may be reversed such that the face cloth 30b is located between the outer shell 26 and the bulk layer 30a. In one embodiment, the thermal barrier 30 (or the garment 10 as a whole) may have a thermal protection performance (“TPP”) of at least about twenty, and the garment 10 as a whole may have a TPP of at least about thirty-five, although the TPP values can vary. If desired, the thermal barrier 30 may be treated with a water-resistant or water-repellent finish.

Although the moisture barrier 28 is shown as being located between the outer shell 26 and the thermal barrier 30, the positions of the moisture barrier 28 and thermal barrier 30 may be reversed such that the thermal barrier 30 is located between the outer shell 26 and the moisture barrier 28, or various other orientations or configurations may be used.

The face cloth 32 may be the innermost layer of the garment 10, located inside the thermal barrier 30 and moisture barrier 28. The face cloth 32 can provide a comfortable surface for the wearer and protect the thermal barrier 30 and/or moisture barrier 28 from abrasion and wear. The face cloth 32 may be quilted to the adjacent layer (i.e. the thermal barrier 30 in the illustrated embodiment). However, the face cloth 32 is optional and may be excluded if desired. In addition, the garment 10 may not necessarily include the moisture barrier 28 and/or the thermal barrier 30 in certain cases.

Each layer of the garment 10 disclosed herein, including the layers and components described above, as well as those described below, and the garment 10 as a whole, may meet the National Fire Protection Association (“NFPA”) 1971 standards for protective firefighting garments (“Protective Clothing for Structural Firefighting”), which standards as of the filing date of this application are entirely incorporated by reference herein. The NFPA standards specify various minimum requirements for heat and flame resistance and tear strength. For example, in order to meet the NFPA standards, the outer shell 26, moisture barrier 28, thermal barrier 30 and face cloth 32 must be able to resist igniting, burning, melting, dripping, separation, and/or shrinking more than 10% in any direction after being exposed to a temperature of 500° F. for at least five minutes. Furthermore, in order to meet the NFPA standards, the combined layers of the garment 10 must provide a thermal protective performance rating of at least thirty-five.

Alternately or in addition to the NFPA Standard 1971, the garment 10 disclosed herein may also meet European Norm (“EN”) standards for firefighting garments set by the European Committee for Standardization (also known as Comité Européen de Normalisation (“CEN”)). These standards include EN 469:2005 Level 1 and Level 2 certification. The EN standards for firefighter and protective garments in place as of the filing date of this application are entirely incorporated by reference herein.

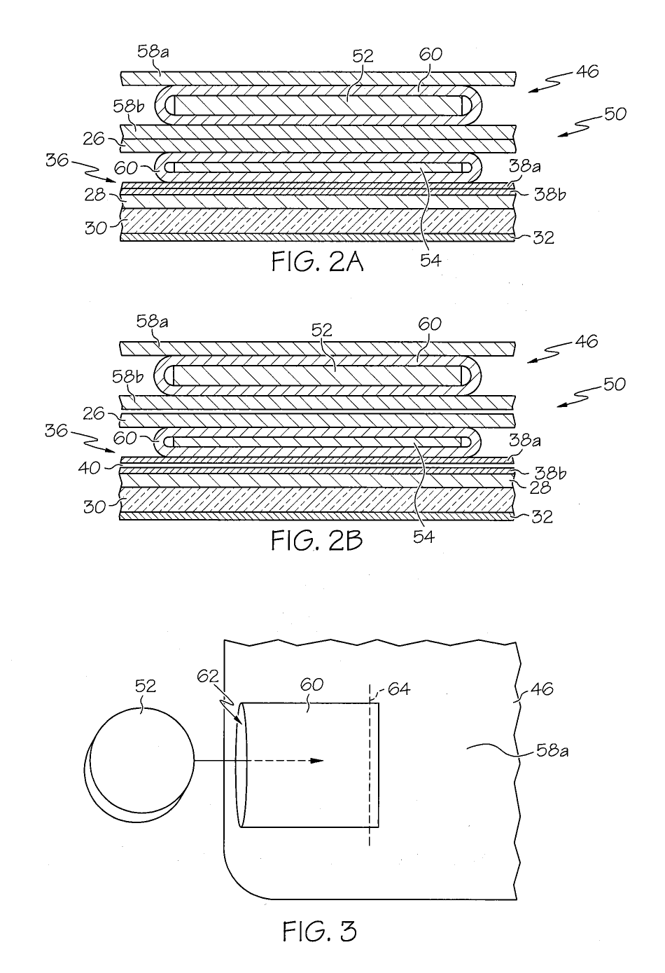

The garment 10 may include one or more pockets 36 thereon or therein in which the wearer can store various items, including but not limited to, goggles, gloves, hand tools and other loose items. As best shown in FIGS. 2A and 2B, in one embodiment each pocket 36 includes a body defined by a pair of opposed pocket liner panels 38a, 38b. The pocket liner panels 38a, 38b can be secured together about their outer periphery (i.e., as shown by the dotted lines in FIG. 1) to define a pocket cavity 40 (FIG. 2B) therebetween. The pocket liner panels 38a, 38b are free or uncoupled along an upper portion or length thereof to define a mouth 42 of the pocket 36 (FIG. 1). In the illustrated embodiment, the mouth 42 of the pocket 36 is formed by or in communication with a slit or opening 44 formed in the outer shell 26. The mouth 42/pocket 36 may be externally accessible to allow the wearer to place items into, and remove items from, the pocket cavity 40.

Each pocket 36 may include a closure flap 46 that is moveable between a closed position wherein the closure flap 46 generally covers the associated mouth 42 (flap 46b of FIG. 1) and an open position wherein the closure flap 46 generally does not cover the associated mouth 42 (flap 46a of FIG. 1). When the flap 46 is in the closed position, the flap 46 generally traps components positioned in the pocket cavity 40 and prevents further components from being added to the pocket cavity 40. In contrast, when the flap 46 is open, the flap 46 does not prevent contents from being removed from or added to the pocket cavity 40. In the illustrated embodiment, each flap 46 is directly pivotally coupled to the outer shell 26.

Each pocket 36 may include a closure flap retaining system, generally designated 50, for retaining the closure flap 46 in the closed position. In particular, in one embodiment each flap 46 includes a pair of spaced apart pieces of magnetic or magnetizable material 52 carried thereon. Correspondingly-positioned, spaced-apart pieces 54 of magnetic or magnetizable material are positioned on the body 12 of the garment 10/pocket 36. In this manner, when each flap 46 is in its closed position, each piece of material 52 on the flap 46 magnetically interacts with a corresponding piece of material 54 on the body of the garment 10/pocket 36 to retain the pocket 36 in its closed position.

In one embodiment the pieces 52 on the flap 46 and the pieces 54 on the body 12 are both made of magnets or magnetic material, such as a ferromagnetic or permanently magnetic material. Alternately, in one embodiment at least one piece 52/54 in an associated pair of pieces 52/54 can be made of non-magnetic, but magnetizable, material, such as ferrous materials or the like, and the other piece 52/54 is made of magnets or magnetic material.

Because the garment 10 is designed to be exposed to high temperatures and other harsh conditions, the pieces 52/54 may be made of material sufficient to withstand such harsh conditions. For example, in one case, the pieces 52/54 of magnetic material/magnetizable material must be able to pass NFPA 1971 requirements, including resisting igniting, burning, melting, dripping or separation when exposed to a temperature of 500° F. for five minutes, and also retain magnetic properties. In addition, the pieces 52/54 of magnetic/magnetizable material must be capable of withstanding the NFPA 1971 salt spray test. In one case the pieces 52/54 of magnetic material can be made of high temperature resistant magnetic materials, which are magnetic materials that retain their magnetic properties when exposed to elevated temperatures, including temperatures above about 150° C., or above about 200° C., or above about 250° C. The high temperature resistant magnetic materials can include AlNiCo rare earth magnet, NdFeB rare earth magnet, SmCo rare earth magnet, sintered SmCo magnet, sintered NdFeB rare earth magnet, SmCo5 and Sm2Co17 magnets, SH grade neodymium magnets, nickel cadmium magnets and samarium cobalt magnets.

As can be seen in FIGS. 2A and 2B, the pockets 36/pocket panels 38a, 38b can be positioned between the outer shell 26 and the moisture barrier 28/thermal barrier 30. In addition, the pieces 54 of magnetic/magnetizable material on the body 12 can be positioned between the pocket 36 and the outer shell 26, and in the illustrated embodiment pieces 54 are positioned externally of the pocket cavity 40. Although the pieces 54 of magnetic/magnetizable material can be located at various other positions throughout the thickness of the garment 10, positioning the pieces 54 of magnet/magnetizable material as close as possible to the outer shell 26 (i.e. in the illustrated embodiment, outside the moisture barrier 28 and thermal barrier 30 and immediately adjacent to the outer shell 26) helps to provide a greater magnetic interaction between the pieces 52/54 of magnetic pair. This, in turn, enables the pieces 52/54 of magnet/magnetizable material to be able to be made smaller, which reduces weight and bulk of the garment 10.

As shown in FIGS. 2A and 2B, in the illustrated embodiment each flap 46 includes a pair of flap panels 58a, 58b which receive the pieces 52 of magnet/magnetizable material therebetween. The flap panels 58a, 58b can be made of a variety of materials, but in one embodiment are made of the same materials as the outer shell 26. Of course, the pieces 52 of magnets/magnetizable material can be placed at various other positions throughout the thickness of the flap 46.

FIG. 3 illustrates one embodiment of a structure for coupling the pieces 52, 54 of magnet/magnetizable material to the associated component (i.e., flap, pocket, garment, etc.). In particular, in this embodiment the piece 52 is closely received in a pouch 60 which generally surrounds and traps the piece 52 therein. The pouches 60 can be made of a wide variety of materials, but in one case are made of a lightweight fire-resistant material, such as the materials outlined above for the liner of the thermal barrier 30 and/or moisture barrier 28. In the illustrated embodiment the pouch 60 is generally square having a side length equal to, or slightly longer than, the diameter of the circular piece 52. However, the piece 52 and pouch 60 can have any of a variety of shapes or sizes. After the piece 52 is positioned in the pouch 60, the open mouth 62 of the pouch 60 is then closed by stitching, adhesives, fasteners or the like. The pouch 60 can then be secured in place by stitching extending about the outer perimeter of the pouch 60 (one stitch line 64 of which is shown in FIG. 3) to secure the pouch 60, and thereby the piece 52/54 of magnet/magnetizable material, in place. Alternately, the pouch 60 can be secured in place prior to receiving the piece 52/54 therein.

The use of the pouch 60 provides several benefits. In particular, in some cases, it can be difficult to directly secure the magnet 52 in the desired position. The use of the pouch 60 ensures that the piece of magnet/magnetizable material 52/54 is securely held in place by the use of stitching, which can be an advantageous securing method as compared to, for example, adhesives. Moreover, if it were attempted to directly stitch the piece 52/54 of magnetic/magnetizable material in place, the piece 52/54 will tend to magnetically interact with the footer or other metallic parts of a sewing machine. Accordingly, the use of the pouch 60 can enable the pouch 60 to be quickly tacked in place, and the pouch 60 and piece 52/54 can then later be secured by other means, such as sewing. In this manner, the pouch 60 is used to secure the piece of magnetic/magnetizable 52/54 material to the associated pocket 36, outer shell 26 or flap 46 such that a piece 52/54 of magnetic/magnetizable material is not directly coupled to the associated pocket 36, outer shell 26 or flap 46.

When utilizing a pair of coupling materials 52/54, it may be desired to have one piece 52/54 made of magnetic material, and the other piece 52/54 made of a magnetizable material, such as metal in one case. In particular, a piece of magnetizable material, such as metal, can be more inexpensive and easier to attach as compared to a piece of magnetic material. In this case, in order to provide sufficient magnetic forces, the magnet may be required to be relatively thick.

In one embodiment, the pieces 52 of material not positioned on the body of the garment 10, or positioned on the flap 46, are made of magnetic material, and the pieces 54 of material positioned on the body of the garment 10 and not positioned on the pocket 36/outer shell 26/body 12 of the garment 10 are made of non-magnetic, but magnetizable material. The additional thickness required by the magnetic material 52 as outlined above can cause the piece 52 to protrude forwardly/outwardly. Thus, if a thicker magnetic were used on the body of the garment 10, the thicker portion can present an outwardly-protruding surface on the outer shell 12 which is prone to abrasion and rubbing, which can ultimately cause weakness or even holes to be formed in the outer shell 12. In contrast, the underside of the flap 46 is more protected, and therefore a more appropriate location for the thicker magnet. Accordingly, by utilizing the relatively thin low-profile magnetizable material 54 on the body of the garment 10 and the relatively thicker magnetic material 52 on the flap 14 (as shown in FIGS. 2A and 2B), a more low-profile, durable configuration is provided.

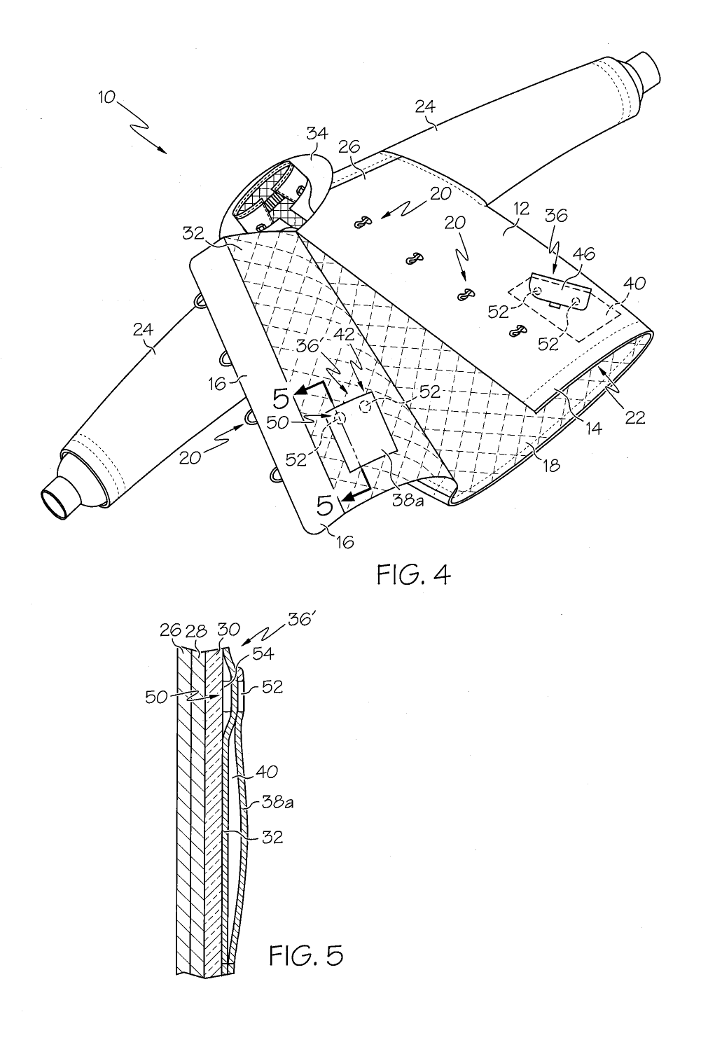

FIG. 1 illustrates the pocket 36 positioned on an outer surface of the garment 10. However, if desired the pocket 36 can be positioned on other surfaces, such as the inner layer/face cloth 32, shown as pocket 36′ in FIGS. 4 and 5. In this case the pocket liner panel 38a can be directly secured to the face cloth layer 32 around the periphery thereof (except the mouth 42), although if desired an inner pocket liner panel 38b can be used.

In addition, the pocket 36′ shown in FIGS. 4 and 5 may lack the closure flap 36, although the closure flap 36 can be used if desired. In cases where the closure flap 36 is not utilized, the pieces of material 52 can be coupled to/embedded in the pocket liner panel 38a, and the other pieces of material 54 can coupled to/embedded in the layer 32 and/or other layers. In this case the potentially thinner, magnetizable material 52 may be carried on the pocket liner panel 38a, and the potentially thicker, magnetic material 54 may be carried on the body of the garment 10, since the piece of material 52 is more exposed during use/laundering. The “flapless” design can also be used on externally positioned pocket 36.

It should be understood that, although the figures illustrate the retaining system 50 in conjunction with a coat, the pockets 36, 36′/retaining system 50 can be used in conjunction with a variety of garments, including trousers, vests, jumpsuits, hoods, etc.

Having described the invention in detail and by reference to the preferred embodiments, it will be apparent that modifications and variations thereof are possible without departing from the scope of the invention.

What is claimed is:

1. A protective garment comprising:
an outer shell made of an abrasion resistant material that resists igniting, burning, melting, dripping, or separation when exposed to a temperature of 500° F. for five minutes;
a pocket generally positioned on or inside said outer shell; and
a magnetic closure system configured to retain said pocket in a closed position, wherein said magnetic closure system resists igniting, burning, melting, dripping, or separation when exposed to a temperature of 500° F. for five minutes.

2. The garment of claim 1 wherein said pocket has a mouth, and wherein said pocket further includes a closure flap movable between a closed position wherein said closure flap generally covers said mouth and an open position wherein said closure flap generally does not cover said mouth, wherein said closure flap is configured to be magnetically retained in said closed position to thereby retain said pocket in said closed position.

3. The garment of claim 1 wherein said pocket includes a piece of pocket liner material coupled to a body of said garment and defining a cavity positioned therebetween, wherein the magnetic closure system is configured to magnetically releasably couple said piece of pocket liner material to said body of said garment to thereby retain said pocket in said closed position.

4. The garment of claim 1 wherein the magnetic closure system includes a first piece of magnetic or magnetizable material coupled to said pocket, and a second piece of magnetic or magnetizable material positioned on a body of said garment, wherein said first and second pieces are configured to magnetically interact to retain said pocket in said closed position.

5. The garment of claim 4 wherein one of said first or second pieces is a magnetic material and the other one of said first or second pieces is a magnetizable but not permanently magnetic material.

6. The garment of claim 5 wherein said piece of magnetic material is a high temperature resistant magnetic material capable of withstanding a NFPA 1971 salt spray test.

7. The garment of claim 4 wherein said pocket defines a pocket cavity, and wherein said second piece is positioned externally of said pocket cavity.

8. The garment of claim 4 wherein at least one of said first or second pieces is closely received in a pouch generally surrounding said at least one of said first or second pieces, and wherein the pouch is directly coupled to the associated pocket or body of the garment, and wherein the at least one of said first or second pieces is not directly coupled to the associated pocket or body of the garment.

9. The garment of claim 1 wherein said pocket is accessible from an outer surface of said garment.

10. The garment of claim 9 further comprising a first piece of magnetic or magnetizable material coupled to said pocket, and a second piece of magnetic or magnetizable material positioned on a body of said garment, wherein said first and second pieces are configured to magnetically interact to retain said pocket in said closed position, the garment further comprising a thermal barrier positioned inside said outer shell such that said thermal barrier is configured to be positioned between said outer shell and a wearer when said garment is worn, and wherein second piece is positioned between said thermal barrier and outer shell.

11. The garment of claim 1 wherein said pocket is accessible from an inner surface of said garment.

12. The garment of claim 11 further comprising a first piece of magnetic or magnetizable material coupled to said pocket, and a second piece of magnetic or magnetizable material positioned on a body of said garment, wherein said first and second pieces are configured to magnetically interact to retain said pocket in said closed position, the garment further comprising an inner-most layer configured to be positioned adjacent to a wearer when said garment is worn, and wherein said second piece is positioned immediately adjacent to said inner-most layer, and positioned such that said inner-most layer is positioned between said second piece and a wearer of said garment when said garment is worn.

13. The garment of claim 1 wherein said pocket has a mouth, and wherein said pocket further includes a closure flap movable between a closed position wherein said closure flap generally covers said mouth and an open position wherein said closure flap generally does not cover said mouth, the garment further comprising a first piece of magnetic or magnetizable material coupled to said flap, and a second piece of magnetic or magnetizable material positioned on a body of said garment, wherein said first and second pieces are configured to magnetically interact to magnetically retain said flap in said closed position to thereby retain said pocket in said closed position.

14. The garment of claim 13 wherein said flap includes an inner layer of material and an outer layer of material, and wherein said first piece is positioned between said inner and outer layers.

15. The garment of claim 13 wherein said first piece of material is a magnetic material and said second piece of material is magnetizable but not permanently magnetic material.

16. The garment of claim 13 wherein said piece of magnetic material has a greater thickness than said piece of magnetizable but not permanently magnetic material.

17. The garment of claim 13 wherein said flap is directly pivotally coupled to said outer shell.

18. The garment of claim 1 wherein said pocket includes a piece of pocket liner material coupled to a body of said garment and defining a cavity positioned therebetween, wherein the magnetic closure system includes a first piece of magnetic or magnetizable material coupled to said piece of pocket liner, and a second piece of magnetic or magnetizable material positioned on a body of said garment, wherein said first and second pieces are configured to magnetically interact to retain said pocket in said closed position.

19. The garment of claim 18 wherein said first piece of material is a magnetizable but not permanently magnetic material and said second piece of material is magnetic material.

20. The garment of claim 1 further comprising a thermal barrier positioned inside said outer shell such that said thermal barrier is configured to be positioned between said outer shell and a wearer when said garment is worn, wherein said thermal barrier has a TPP of at least about twenty.

21. The garment of claim 1 further comprising a moisture barrier positioned inside said outer shell such that said moisture barrier is configured to be positioned between said outer shell and a wearer when said garment is worn, wherein said moisture barrier is made of a material that is generally liquid impermeable and generally moisture vapor permeable.

22. The protective garment of claim 1 wherein the garment conforms with National Fire Protection Association 1971 Standards for Protective Firefighting Garments.

23. The garment of claim 1 wherein said closure system is configured to retain said pocket in said closed position said pocket is already in said closed position, and is configured to enable said pocket to be manually moved to an open position.

24. A protective garment comprising:
an outer shell;
a thermal barrier positioned inside said outer shell such that said thermal barrier is configured to be positioned between said outer shell and a wearer when said garment is worn;
a moisture barrier positioned inside said outer shell such that said moisture barrier is configured to be positioned between said outer shell and a wearer when said garment is worn, wherein said moisture barrier is made of a material that is generally liquid impermeable and generally moisture vapor permeable;
a pocket generally positioned on or coupled to said outer shell; and
a retaining system configured to magnetically retain said pocket in a closed position.

25. The garment of claim 24 wherein said pocket has a mouth, and wherein said pocket further includes a closure flap movable between a closed position wherein said closure flap generally covers said mouth and an open position wherein said closure flap generally does not cover said mouth, the garment further comprising a piece of magnetic material coupled to said flap, and a piece of magnetizable but not permanently magnetic material positioned on a body of said garment, wherein said pieces are configured to magnetically interact to magnetically retain said flap in said closed position to thereby retain said pocket in said closed position.

26. A method for manufacturing a garment comprising:
providing an outer shell made of an abrasion resistant material that resists igniting, burning, melting, dripping, or separation when exposed to a temperature of 500° F. for five minutes;
positioning or forming a pocket on or inside said outer shell; and
positioning a magnetic closure system on or adjacent to said pocket to retain said pocket in a closed position, wherein said magnetic closure system resists igniting, burning, melting, dripping, or separation when exposed to a temperature of 500° F. for five minutes.
